(19) United States
(12) Patent Application Publication
(10) Pub. No.: US 2026/0011118 A1
(43) Pub. Date: Jan. 8, 2026

(54) AI-BASED IMAGE PROCESSING METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Zhongyi SUN, Shenzhen (CN); Ke YAN, Shenzhen (CN); Shouhong DING, Shenzhen (CN)

(21) Appl. No.: 19/327,787

(22) Filed: Sep. 12, 2025

Related U.S. Application Data
(63) Continuation of application No. PCT/CN2024/103392, filed on Jul. 3, 2024.

(30) Foreign Application Priority Data
Jul. 28, 2023 (CN) 202310937637.2

(51) Int. Cl. G06V 10/74; G06V 10/75; G06V 10/77; G06V 10/82

(52) U.S. Cl. CPC G06V 10/761; G06V 10/751; G06V 10/7715; G06V 10/82

(57) ABSTRACT

An artificial intelligence (AI)-based image processing method includes: acquiring a first image feature and a second image feature of a preset image, and first reference image features and second reference image features of reference images in a first reference image set; determining first matching degrees between the preset image and the reference images in the first reference image set based on the first image feature and the first reference image features, and selecting, based on the first matching degrees, a preset number of reference images from the first reference image set to generate a second reference image set; and determining second matching degrees between the preset image and reference images in the second reference image set based on the second image feature and second reference image features, and determining an image processing result of the preset image based on the second matching degrees.

### CROSS-REFERENCES TO RELATED APPLICATIONS

This application is a continuation of PCT Application No. PCT/CN2024/103392, filed on Jul. 3, 2024, which claims priority to Chinese Patent Application No. 202310937637.2, filed on Jul. 28, 2023, the entire contents of all of which are incorporated herein by reference.

### FIELD OF THE TECHNOLOGY

The present disclosure relates to artificial intelligence (AI) technologies, and in particular, to an AI-based image processing method and apparatus, a device, and a storage medium.

### BACKGROUND OF THE DISCLOSURE

AI involves a theory, a method, a technology, and an application system that use a digital computer or a machine controlled by the digital computer to simulate, extend, and expand human intelligence, perceive an environment, acquire knowledge, and use knowledge to obtain an optimal result.

Image retrieval is an important application of AI. Image features are extracted using a machine learning model, and then the extracted features are matched with features of a reference image in a base library to determine whether two images are similar. It is the most common algorithm solution for an image retrieval task. Since massive input data (i.e., to-be-retrieved images) and a huge base library usually need to be processed during image retrieval, one way to improve the image retrieval efficiency is to simplify the machine learning model to reduce a calculation amount of the model during feature extraction; another way is to lower the number of matching times of the base library to reduce the matching time consumption. Although these methods could improve the image retrieval efficiency to some extent, they also affect the image retrieval precision.

Therefore, a contradiction between the image retrieval efficiency and the image retrieval precision becomes a difficult technical problem to be solved.

### SUMMARY

Embodiments of the present disclosure provide an AI-based image processing method and apparatus, an electronic device, a computer-readable storage medium, and a computer program product, which can improve the image processing precision while improving the image processing efficiency.

Technical solutions of the embodiments of the present disclosure are implemented as follows.

The embodiments of the present disclosure provide an AI-based image processing method, including the following operations: acquiring a first image feature and a second image feature of a preset image, and first reference image features and second reference image features of reference images in a first reference image set, a dimension of the first image feature and a dimension of each of the first reference image features being the same, a dimension of the second image feature and a dimension of each of the second reference image features being the same, and the dimension of the first image feature being less than the dimension of the second image feature; determining first matching degrees between the preset image and the reference images in the first reference image set based on the first image feature and the first reference image features of the reference images in the first reference image set, and selecting, based on the first matching degrees, a preset number of reference images from the first reference image set to generate a second reference image set; and determining second matching degrees between the preset image and reference images in the second reference image set based on the second image feature and second reference image features of the reference images in the second reference image set, and determining an image processing result of the preset image based on the second matching degrees.

The embodiments of the present disclosure provide an AI-based image processing apparatus, including: an acquisition module configured to acquire a first image feature and a second image feature of a preset image, and first reference image features and second reference image features of reference images in a first reference image set, a dimension of the first image feature and a dimension of each of the first reference image features being the same, a dimension of the second image feature and a dimension of each of the second reference image features being the same, and the dimension of the first image feature being less than the dimension of the second image feature; a screening module configured to determine first matching degrees between the preset image and the reference images in the first reference image set based on the first image feature and the first reference image features of the reference images in the first reference image set, and selecting, based on the first matching degrees, a preset number of reference images from the first reference image set to generate a second reference image set; and a determining module configured to determine second matching degrees between the preset image and reference images in the second reference image set based on the second image feature and second reference image features of the reference images in the second reference image set, and determine an image processing result of the preset image based on the second matching degrees.

The embodiments of the present disclosure provide an electronic device, including: a memory configured to store a computer-executable instruction or a computer program; and a processor configured to implement, when executing the computer-executable instruction or the computer program stored in the memory, the AI-based image processing method provided in the embodiments of the present disclosure.

The embodiments of the present disclosure provide a non-transitory computer-readable storage medium, having a computer-executable instruction or a computer program stored therein, and the computer-executable instruction or the computer program being configured for implementing, when executed by a processor, the AI-based image processing method provided in the embodiments of the present disclosure.

The embodiments of the present disclosure provide a computer program product, including a computer program or a computer-executable instruction, and the computer program or the computer-executable instruction, when executed by a processor, implementing the AI-based image processing method provided in the embodiments of the present disclosure.

The embodiments of the present disclosure have the following beneficial effects.

According to the embodiments of the present disclosure, when the preset image is processed, the first matching degrees between the preset image and the reference images in the first reference image set are first determined based on the first image feature of the preset image and the first reference image features of the reference images in the first reference image set, and based on the first matching degrees, a preset number of reference images are selected from the first reference image set to generate the second reference image set. Then, the second matching degrees between the preset image and the reference images in the second reference image set are determined based on the second image feature of the preset image and the second reference image features of the reference images in the second reference image set, and the image processing result of the preset image is determined based on the second matching degrees. The dimension of the first image feature and the dimension of the first reference image feature are the same, the dimension of the second image feature and the dimension of the second reference image feature are the same, and the dimension of the first image feature is less than the dimension of the second image feature. During first-stage matching, a particular number of reference images are first screened through the matching of low-dimensional image features, which can reduce the matching time consumption required for most image processing, thereby improving the image processing efficiency. Then, during second-stage matching, for a relatively small number of screened reference images, matching is performed using high-dimensional image features to determine the image processing result. The high-dimensional image feature can capture more detailed and complex information in the preset image and characterize more abundant information content. Therefore, when the preset image is processed according to a high-dimensional feature with abundant information, information such as a texture, a shape, a color, and a structure of the preset image may be described more comprehensively, and the image processing accuracy can be ensured. In this way, through two stages of matching, the image processing efficiency is balanced with the image processing precision. That is, when the image processing efficiency is improved, a defect that the image processing accuracy cannot be ensured is eliminated.

### BRIEF DESCRIPTION OF THE DRAWINGS

FIG. 1 is a schematic structural diagram of an AI-based image processing system according to an embodiment of the present disclosure.

FIG. 2 is a schematic structural diagram of an electronic device according to an embodiment of the present disclosure.

FIG. 3A is a first schematic flowchart of an AI-based image processing method according to an embodiment of the present disclosure.

FIG. 3B is a second schematic flowchart of an AI-based image processing method according to an embodiment of the present disclosure.

FIG. 3C is a third schematic flowchart of an AI-based image processing method according to an embodiment of the present disclosure.

FIG. 3D is a fourth schematic flowchart of an AI-based image processing method according to an embodiment of the present disclosure.

FIG. 3E is a fifth schematic flowchart of an AI-based image processing method according to an embodiment of the present disclosure.

FIG. 4 is a schematic structural diagram of a feature extraction model according to an embodiment of the present disclosure.

FIG. 5 is a schematic flowchart of AI-based image processing according to an embodiment of the present disclosure.

### DESCRIPTION OF EMBODIMENTS

To make the objectives, technical solutions, and advantages of the present disclosure clearer, the present disclosure will be described in further detail below with reference to the accompanying drawings. The described embodiments are not to be considered as a limitation to the present disclosure. All other embodiments obtained by a person skilled in the art without creative efforts shall fall within the protection scope of the present disclosure.

The term, involved in the following description, “some embodiments” describes subsets of all possible embodiments, but “some embodiments” may be the same subset or different subsets of all the possible embodiments and may be combined with each other without conflict.

The term, involved in the following description, “first/second . . . ” is merely intended to distinguish similar objects rather than describing specific orders of the objects. The “first/second . . . ” is interchangeable in proper circumstances to enable the embodiments of the present disclosure described herein to be implemented in other orders than those illustrated or described herein.

Unless defined otherwise, all technical and scientific terminologies used herein have the same meaning as commonly understood by a person skilled in the art to which the present disclosure belongs. Terms used herein are merely intended to describe the embodiments of the present disclosure, but are not intended to limit the present disclosure.

Embodiments of the present disclosure provide an AI-based image processing method and apparatus, an electronic device, a computer-readable storage medium, and a computer program product, which can improve the image processing precision while improving the image processing efficiency.

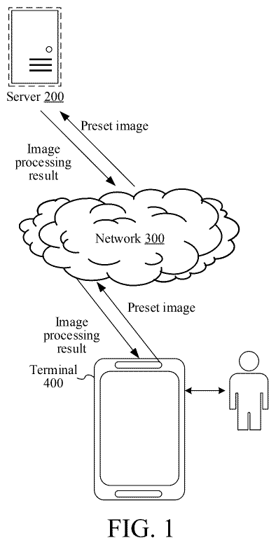

The AI-based image processing provided in the embodiments of the present disclosure may be performed by various electronic devices, for example, may be performed by a terminal device or a server alone, or may be collaboratively performed by the terminal and the server. Exemplary application when the electronic device is implemented as a server in an image processing system is described below. FIG. 1 is a schematic structural diagram of an AI-based image processing system according to an embodiment of the present disclosure. A terminal 400 is connected to a server 200 through a network 300. The network 300 may be a wide area network, a local area network, or a combination of the two.

In some embodiments, the server 200 may be an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and AI platform. The terminal 400 may include, but is not limited to, a mobile phone, a computer, an intelligent voice interaction device, an intelligent household appliance, an in-vehicle terminal, and the like. The terminal may be directly or indirectly connected to the server in a wired or wireless communication manner. This is not limited in the embodiments of the present disclosure.

In some embodiments, functions of the AI-based image processing system are implemented based on the server 200. The server 200 acquires a preset image from the terminal 400 and acquires a first image feature and a second image feature of the preset image, and first reference image features and second reference image features of reference images in a first reference image set. A dimension of the first image feature and a dimension of each of the first reference image features are the same, a dimension of the second image feature and a dimension of each of the second reference image features are the same, and the dimension of the first image feature is less than the dimension of the second image feature. The server 200 determines first matching degrees between the preset image and the reference images in the first reference image set based on the first image feature and the first reference image features of the reference images in the first reference image set, and selects, based on the first matching degrees, a preset number of reference images from the first reference image set to generate a second reference image set. The server 200 determines the second matching degrees between the preset image and reference images in the second reference image set based on the second image feature of the preset image and second reference image features of the reference images in the second reference image set, determines an image processing result of the preset image based on the second matching degrees, and transmits the image processing result of the preset image to the terminal 400.

In other embodiments, the embodiments of the present disclosure may alternatively be implemented through a cloud technology. The cloud technology refers to a hosting technology that unifies a series of resources such as hardware, software, and networks within a wide area network or a local area network to implement data calculation, storage, processing, and sharing.

The cloud technology is a generic term of a network technology, an information technology, an integration technology, a management platform technology, and an application technology based on application of a cloud computing business model. It may form a resource pool and may be used on demand, which is flexible and convenient. The cloud computing technology will become an important support. Backend services of a technology network system require a lot of computing and storage resources.

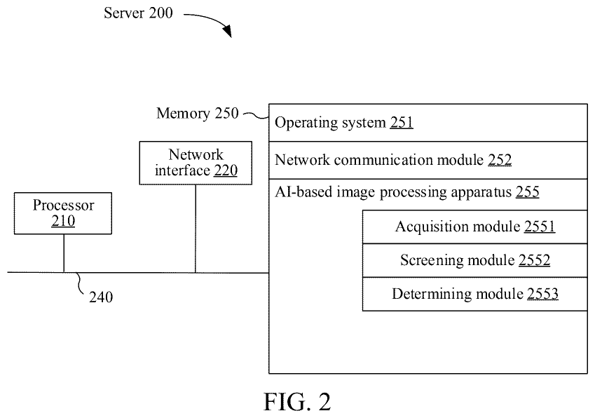

Next, a structure of an electronic device configured to implement the AI-based image processing method provided in the embodiments of the present disclosure is described. As described above, the electronic device provided in the embodiments of the present disclosure may be the server 200 in FIG. 1. FIG. 2 is a schematic structural diagram of an electronic device according to an embodiment of the present disclosure. The terminal 200 shown in FIG. 2 includes: at least one processor 210, a memory 250, and at least one network interface 220. Components in the server 200 are coupled together through a bus system 240. The bus system 240 is configured to implement connection and communication between the components. In addition to a data bus, the bus system 240 further includes a power bus, a control bus, and a state signal bus. However, for clear description, all types of buses in FIG. 2 are marked as the bus system 240.

The processor 210 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The memory 250 may be a removable memory, a non-removable memory, or a combination thereof. Exemplary hardware devices include a solid-state memory, a hard disk drive, a compact disc (CD) drive, and the like. The memory 250 alternatively includes one or more storage devices physically located away from the processor 210.

The memory 250 includes a volatile memory or a non-volatile memory, or may include both the volatile memory and the non-volatile memory. The non-volatile memory may be a read only memory (ROM). The volatile memory may be a random access memory (RAM). The memory 250 described in this embodiment of the present disclosure is intended to include any suitable type of memory.

In some embodiments, the memory 250 can store data to support various operations. Examples of the data include a program, a module, and a data structure, or their subsets or supersets, which are exemplified below.

An operating system 251 includes a system program configured for processing various basic system services and performing hardware-related tasks, such as a framework layer, a core library layer, or a driver layer, to implement various basic businesses and process the hardware-based tasks. A network communication module 252 is configured to reach other electronic devices via one or more (wired or wireless) network interfaces 220. Illustratively, the network interface 220 includes: Bluetooth, wireless fidelity (WiFi), a universal serial bus (USB), and the like.

In some embodiments, the AI-based image processing apparatus provided in this embodiment of the present disclosure may be implemented in a software manner. FIG. 2 shows an AI-based image processing apparatus 255 stored in the memory 250. The apparatus 255 may be software in the form of a program, a plug-in, or the like, and includes the following software modules: an acquisition module 2551, a screening module 2552, and a determining module 2553. These modules are logical, and therefore may be arbitrarily combined or further split according to implemented functions. The functions of the modules will be described below.

In some embodiments, the terminal or the server may implement, by running a computer program, the AI-based image processing method provided in the embodiments of the present disclosure. For example, the computer program may be an original program (for example, a dedicated image processing program) or a software module in an operating system, may be a native application (APP), i.e., a program that needs to be installed in the operating system to run, or may be a mini program that can be embedded into any APP, i.e., a program that only needs to be downloaded into a browser environment to run. In summary, the foregoing computer program may be an APP, a module, or a plug-in in any form.

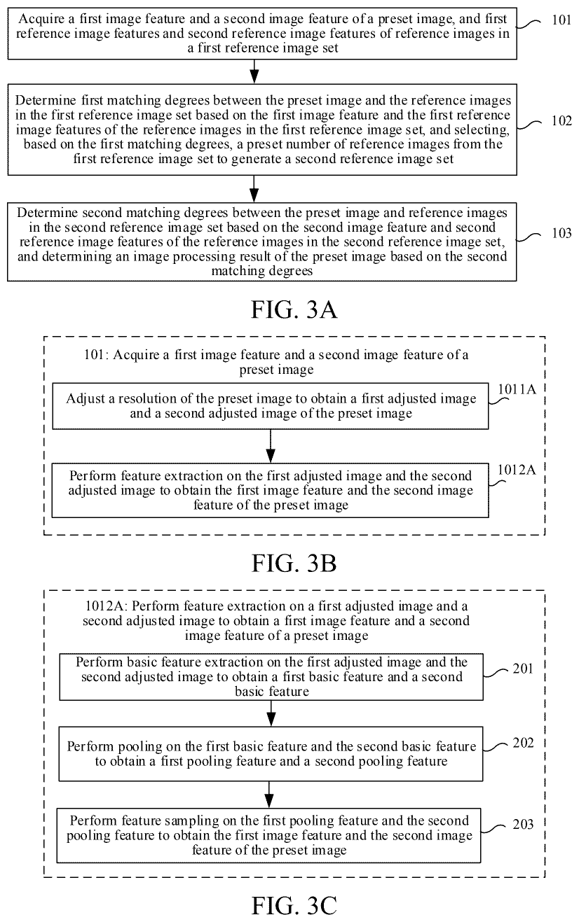

The AI-based image processing method provided in the embodiments of the present disclosure is described with reference to exemplary application and implementations of the server 200 provided in the embodiments of the present disclosure. FIG. 3A is a first schematic flowchart of an AI-based image processing method according to an embodiment of the present disclosure. The method includes the following operations.

Operation 101: Acquire a first image feature and a second image feature of a preset image, and first reference image features and second reference image features of reference images in a first reference image set.

A dimension of the first image feature and a dimension of each of the first reference image features are the same, a dimension of the second image feature and a dimension of each of the second reference image features are the same, and the dimension of the first image feature is less than the dimension of the second image feature. For example, the dimension of the first image feature and the dimension of the first reference image feature are each a first dimension, and the dimension of the second image feature and the dimension of the second reference image feature are each a second dimension, and the first dimension is less than the second dimension.

In some embodiments, FIG. 3B is a second schematic flowchart of an AI-based image processing method according to an embodiment of the present disclosure. The acquiring a first image feature and a second image feature of a preset image in operation 101 in FIG. 3A may be implemented through operation 1011A to operation 1012A shown in FIG. 3B.

Operation 1011A: Adjust a resolution of the preset image to obtain a first adjusted image and a second adjusted image of the preset image.

In actual application, before feature extraction is performed on the preset image, the same preset image may be adjusted to different resolutions to obtain a first adjusted image and a second adjusted image with different resolutions. Adjustment ranges of the resolutions are determined according to the actual situation. Usually, a higher resolution of an image indicates more abundant features extracted from the image, and a more precise image processing result obtained after feature matching is performed based on the extracted features. However, in this case, calculation amounts of feature extraction and extraction matching are larger, resulting in lower image processing efficiency. Therefore, in actual application, the accuracy and the efficiency of the image processing result need to be balanced to determine the adjustment ranges of the image resolutions.

For example, a preset image with a resolution of 1,024*1,024 is resampled into adjusted images with different resolutions through bilinear interpolation. Experimental verification shows that the preset image may be adjusted to obtain a first adjusted image with a resolution of 160*160 and a second adjusted image with a resolution of 224*224, and subsequent feature extraction and feature matching are performed based on the first adjusted image and the second adjusted image so that a relatively high image processing efficiency can be ensured while improving the image processing accuracy.

In actual application, following the foregoing example, if the resolution of the preset image is 224*224, the resolution of the preset image needs to be adjusted to 160*160. That is, an adjusted image with the resolution of 160*160 is used as the first adjusted image, and an original preset image (with the resolution of 224*224) is used as the second adjusted image to perform subsequent feature extraction and matching.

Operation 1012A: Perform feature extraction on the first adjusted image and the second adjusted image to obtain the first image feature and the second image feature of the preset image.

In image processing, the dimension of an image feature refers to the number of features used for describing the image feature, and the feature usually refers to representation of some particular attributes in an image, such as a color, a texture, a shape, and a position. A feature may be flattened into a one-dimensional vector. The feature vector is a vector representation of combining multiple features in an image. A dimension of the feature vector refers to the number of elements included in the feature vector. Each element in the feature vector represents a value of a particular image feature. For example, a feature vector of an image may include values of color channels of red, green, and blue color spaces, texture roughness of the image, coordinates of edge points, and the like. For example, if an image is processed into a feature vector with dimensions of 1,000, the vector represents values of the image on 1,000 different features and may be considered as points of the image in a 1,000-dimensional space.

Feature extraction of different dimensions may be performed on the first adjusted image of the preset image to obtain image features of different dimensions of the first adjusted image, for example, an image feature of a first dimension and an image feature of a second dimension that correspond to the first adjusted image. In addition, feature extraction of different dimensions is performed on the second adjusted image to obtain image features of different dimensions that correspond to the second adjusted image, for example, an image feature of a first dimension and an image feature of a second dimension that correspond to the second adjusted image. The first dimension is less than the second dimension.

Herein, the image feature of the first dimension of the first adjusted image and the image feature of the first dimension of the second adjusted image may each be referred to as the first image feature of the preset image, and one image feature may be selected therefrom as the first image feature of the preset image. For example, the image feature of the first dimension of the first adjusted image is used as the first image feature of the preset image. Similarly, the image feature of the second dimension of the first adjusted image and the image feature of the second dimension of the second adjusted image may each be referred to as the second image feature of the preset image, and one image feature may be selected therefrom as the second image feature of the preset image. For example, the image feature of the second dimension of the second adjusted image is used as the second image feature of the preset image.

For example, feature extraction of different dimensions is performed on the first adjusted image with the resolution of 160*160 to obtain a 128-dimensional feature vector (i.e., the image feature of the first dimension of the first adjusted image, i.e., the first image feature) and a 512-dimensional feature vector (i.e., the image feature of the second dimension of the first adjusted image, i.e., the second image feature). For another example, feature extraction of different dimensions is performed on the second adjusted image with the resolution of 224*224 to obtain a 128-dimensional feature vector (i.e., the image feature of the first dimension of the second adjusted image, i.e., the first image feature) and a 512-dimensional feature vector (i.e., the image feature of the second dimension of the second adjusted image, i.e., the second image feature).

In some embodiments, FIG. 3C is a third schematic flowchart of an AI-based image processing method according to an embodiment of the present disclosure. Operation 1012A in FIG. 3B may be implemented through operation 201 to operation 203 shown in FIG. 3C. Operation 201: Perform basic feature extraction on the first adjusted image and the second adjusted image to obtain a first basic feature and a second basic feature. For example, the first adjusted image and the second adjusted image of the preset image are inputted into a trained feature extraction model. The feature extraction model includes a convolution layer configured to extract basic features. A convolution result of the first adjusted image outputted at the convolution layer may be used as the first basic feature of the first adjusted image, and a convolution result of the second adjusted image outputted at the convolution layer may be used as the second basic feature of the second adjusted image. Both the first basic feature and the second basic feature may be considered as basic features of the preset image.

Operation 202: Perform pooling on the first basic feature and the second basic feature to obtain a first pooling feature and a second pooling feature.

In actual application, the foregoing pooling may be performed on an entire feature map. For example, after basic feature extraction is performed on the first adjusted image with the resolution of 160*160, a feature map with a size of W₁*H₁*K may be generated, where K is the number of channels of outputting a feature map. After basic feature extraction is performed on the feature map, a generated 3-dimensional tensor (i.e., the first basic feature) may be considered as a set of 2-dimensional feature maps, and the set may be represented using a mathematical formula as follows: X={Xᵢ}, i=1, 2, . . . , K, where K represents a K^{th} channel of the feature map, and Xᵢ represents a two-dimensional feature map of an i^{th} channel. Generally, Xᵢ will be changed into a one-dimensional vector f through an average pooling or maximum pooling operation and represented as a feature vector of an image. However, in a forward or back propagation process, the average pooling tends to easily ignore the importance of local information. However, in the forward or back propagation process, the maximum pooling only retains a response point with a maximum response value so that features have differentiation, but lack the correlation between information. Therefore, in this embodiment of the present disclosure, pooling is performed using generalized average pooling shown in formula (1).

$$f = {[ {f}_{1} , {f}_{2} , … , {f}_{i} , … , {f}_{K} ]}^{T} , {f}_{K} = {( \frac{1}{\vert {X}_{i} \vert} {\sum }_{x ∈ {X}_{i}} {x}^{α} )}^{\frac{1}{α}} , \qquad ( 1 )$$

where X is an input, fis an outputted pooling feature, and α is a hyperparameter. When α tends to infinity, it is the maximum pooling operation, and when α=1, it is the average pooling operation. α is obtained by learning in the back propagation process. Therefore, the pooling feature obtained through generalized average pooling can retain the differentiation of a maximum pooling feature and the correlation of average pooling, thereby obtaining a more effective feature vector.

That is, pooling is performed on the first basic feature (i.e., the input) through the formula (1) to obtain the first pooling feature. Pooling is performed on the second basic feature (i.e., the input) through the formula (1) to obtain the second pooling feature. The first pooling feature and the second pooling feature can retain the differentiation and correlation between the first basic feature and the second basic feature. In this way, a cognitive process of human vision for the preset image can be effectively simulated, thereby effectively extracting abundant characteristic information from the preset image.

In addition, through the pooling, a space size of the feature map (i.e., the first basic feature and the second basic feature) is reduced, and the calculation complexity and storage requirements are reduced. When subsequent matching calculation is performed based on the first pooling feature and the second pooling feature, the time consumption of matching calculation can be reduced, thereby improving the image processing efficiency.

Operation 203: Perform feature sampling on the first pooling feature and the second pooling feature to obtain the first image feature and the second image feature of the preset image.

The feature sampling is further dimension reduction on the pooling features (i.e., the first pooling feature and the second pooling feature) to perform matching calculation on the low-dimensional image features (i.e., the image feature of the first dimension and the image feature of the second dimension) obtained through dimension reduction so that the time consumption of matching calculation can be reduced, thereby improving the image processing efficiency.

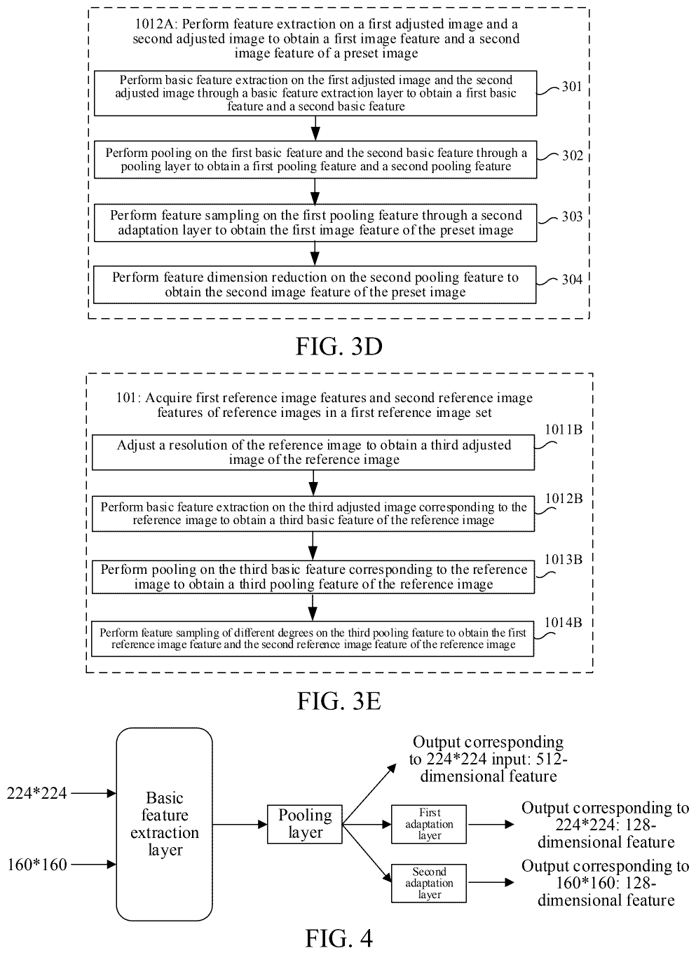

In some embodiments, FIG. 4 is a schematic structural diagram of a feature extraction model according to an embodiment of the present disclosure. The feature extraction model includes a basic feature extraction layer, a pooling layer, a first adaptation layer, and a second adaptation layer. The basic feature extraction layer may be considered as a convolution layer and is configured to extract basic features of an image. The first adaptation layer and the second adaptation layer are configured to perform further feature sampling on the pooling features to implement dimension reduction on the pooling features.

In some embodiments, the performing feature extraction on the first adjusted image and the second adjusted image of the preset image in operation 201 shown in FIG. 3B is implemented by invoking the feature extraction model shown in FIG. 4. FIG. 3D is a fourth schematic flowchart of an AI-based image processing method according to an embodiment of the present disclosure. Operation 1012A in FIG. 3B may be implemented through operation 301 to operation 304 shown in FIG. 3D. Operation 301: Perform basic feature extraction on the first adjusted image and the second adjusted image through the basic feature extraction layer to obtain the first basic feature and the second basic feature.

In actual application, the basic feature extraction layer may be considered as a convolution layer configured to extract features. The first adjusted image and the second adjusted image are inputted into the basic feature extraction layer (i.e., the convolution layer) in the feature extraction model. A convolution result of the first adjusted image outputted at the convolution layer is used as the first basic feature of the first adjusted image, and a convolution result of the second adjusted image outputted at the convolution layer is used as the second basic feature of the second adjusted image.

Operation 302: Perform pooling on the first basic feature and the second basic feature through the pooling layer to obtain the first pooling feature and the second pooling feature.

In actual application, pooling may be performed on the first basic feature and the second basic feature using the generalized average pooling formula of the foregoing formula (1) to obtain the first pooling feature of the first basic feature and the second pooling feature of the second basic feature. Since the pooling features obtained through generalized average pooling can retain the differentiation and correlation between the features, that is, the first pooling feature and the second pooling feature can retain the differentiation and correlation between the first basic feature and the second basic feature, a generalized average pooling policy is used in the feature extraction process so that the cognitive process of human vision for the preset image can be effectively simulated, thereby effectively extracting abundant characteristic information from the preset image. In addition, through processing, space sizes of the first basic feature and the second basic feature are reduced, and the calculation complexity and storage requirements are reduced. When subsequent matching calculation is performed based on the first pooling feature and the second pooling feature, the time consumption of matching calculation can be reduced, thereby improving the image processing efficiency.

Operation 303: Perform feature sampling on the first pooling feature through the second adaptation layer to obtain the first image feature of the preset image. Operation 304: Perform feature dimension reduction on the second pooling feature to obtain the second image feature of the preset image.

Herein, the first adaptation layer and the second adaptation layer are configured to perform dimension reduction on the pooling features (i.e., the first pooling feature and the second pooling feature) to perform matching calculation on the low-dimensional image features (i.e., the first image feature and the second image feature) obtained through dimension reduction so that the time consumption of matching calculation can be reduced, thereby improving the image processing efficiency.

In an actual application, the first adaptation layer and the second adaptation layer may be a fully-connected network or a multilayer perceptron network, and the number of network layers may be set according to an actual requirement to extract low-dimensional features satisfying the requirement. For example, assuming that when the feature extraction model is trained, the first adaptation layer is configured to acquire an image feature of a first dimension (for example, a 128*1*1-dimensional feature, corresponding to an adjusted image with a resolution of 224*224) corresponding to a fifth adjusted image of an image sample, and the second adaptation layer is configured to acquire an image feature of a first dimension (for example, a 128*1*1-dimensional feature, corresponding to an adjusted image with a resolution of 160*160) corresponding to a fourth adjusted image of the image sample. Assuming that a resolution of each reference image in the first reference image set for matching is 224*224, a first reference image feature of each reference image is a 128*1*1-dimensional feature, and a second reference image feature of each reference image is a 512*1*1-dimensional feature, after the resolution of the preset image is adjusted to generate the first adjusted image (with the resolution of 160*160) and the second adjusted image (with the resolution of 224*224), when feature extraction is performed on the first adjusted image and the second adjusted image, the basic feature extraction layer and the pooling layer in the feature extraction model may be shared. That is, the first adjusted image is processed by the basic feature extraction layer and the pooling layer to output a 512*4*4-dimensional feature (i.e., the first pooling feature), and the second adjusted image is processed by the basic feature extraction layer and the pooling layer to output a 512*7*7-dimensional feature (i.e., the second pooling feature).

However, since a difference between the first adjusted image (with the resolution of 160*160) and the reference image (with the resolution of 224*224) is greater than a difference between the second adjusted image (with the resolution of 224*224) and the reference image (with the resolution of 224*224), when feature sampling is performed on the first pooling feature (512*4*4-dimensional feature) of the first adjusted image, the second adaptation layer with a relatively complex structure (for example, the second adaptation layer is of a spindle-shaped structure including two fully-connected layers) may be adopted to perform feature sampling to obtain the image feature of the first dimension (i.e., the first image feature, for example, a 128*1*1-dimensional feature, corresponding to the first adjusted image with the resolution of 160*160) of the first adjusted image. When feature sampling is performed on the second pooling feature (512*7*7-dimensional feature) of the second adjusted image, dimension reduction may be performed on the second pooling feature of the second adjusted image to obtain the image feature of the second dimension (i.e., the second image feature, for example, a 512*1*1-dimensional feature, corresponding to the second adjusted image with the resolution of 224*224) of the second adjusted image. When the image feature of the first dimension (i.e., a 128*1*1-dimensional feature, corresponding to the second adjusted image with the resolution of 224*224) of the second adjusted image needs to be acquired, the first adaptation layer with a relatively simple structure (for example, the first adaptation layer includes a fully-connected layer) may be adopted to perform feature sampling to obtain the image feature of the first dimension (i.e., the first image feature) of the second adjusted image.

In some embodiments, the feature extraction model may be obtained through training in the following manner: acquiring an initial feature extraction model and an image sample; training a basic feature extraction layer in the initial feature extraction model based on the image sample to obtain a first feature extraction model; freezing a parameter of a basic feature extraction layer in the first feature extraction model, and training a first adaptation layer in the first feature extraction model to obtain a second feature extraction model; and freezing the parameter of the basic feature extraction layer in the first feature extraction model and a parameter of a first adaptation layer in the second feature extraction model, training a second adaptation layer in the second feature extraction model to obtain a third feature extraction model, and using the third feature extraction model as the feature extraction model.

In actual application, when the feature extraction model is trained, multi-stage training may be performed on the initial feature extraction model, and an extraction model obtained through training in the last training stage is used as a final feature extraction model configured to perform feature extraction on the first adjusted image and the second adjusted image of the preset image. For example, when there are three training stages, in a first training stage, the basic feature extraction layer in the initial feature extraction model is trained based on the image sample to obtain the first feature extraction model (i.e., a model obtained in the first training stage by training the initial feature extraction model). In a second training stage, the parameter of the basic feature extraction layer in the first feature extraction model obtained in the first training stage is fixed, and the first adaptation layer in the first feature extraction model is trained to obtain the second feature extraction model (i.e., a model obtained in the second training stage by training the first feature extraction model obtained through training in the first training stage). In a third training stage, the parameter of the basic feature extraction layer in the first feature extraction model (that is, the parameter of the basic feature extraction layer in the first feature extraction model is used) and the parameter of the first adaptation layer in the second feature extraction model (that is, the parameter of the first adaptation layer in the second feature extraction model is used) are fixed, the second adaptation layer in the second feature extraction model is trained to obtain the third feature extraction model, and the third feature extraction model is used as a finally used feature extraction model. Alternatively, a parameter of a basic feature extraction layer in the second feature extraction model and the parameter of the first adaptation layer in the second feature extraction model are fixed (that is, the parameter of the basic feature extraction layer and the parameter of the first adaptation layer in the second feature extraction model are used), the second adaptation layer in the second feature extraction model is trained to obtain the third feature extraction model, and the third feature extraction model is used as the finally used feature extraction model.

The foregoing feature extraction model (including the initial feature extraction model, the first feature extraction model, the second feature extraction model, and the third feature extraction model) may be any neural network model. An initial neural network model may be trained, and a neural network model obtained through training is used as the feature extraction model. A network structure of the feature extraction model does not constitute a limitation on the embodiments of the present disclosure. In addition, structures of feature extraction models obtained in the training stages are the same. For example, structures of the initial feature extraction model, the first feature extraction model, the second feature extraction model, and the third feature extraction model are the same.

In some embodiments, the basic feature extraction layer in the initial feature extraction model may be trained based on the image sample in the following manner to obtain the first feature extraction model: adjusting a resolution of the image sample to obtain a fourth adjusted image and a fifth adjusted image of the image sample, using the fourth adjusted image of the image sample as a reference sample, using the fifth adjusted image of the image sample as a positive sample, and using other image samples as negative samples; invoking the basic feature extraction layer in the initial feature extraction model to perform basic feature extraction on the reference sample, the positive sample, and the negative sample to obtain a reference sample feature, a positive sample feature, and a negative sample feature; acquiring a first similarity between the reference sample feature and the positive sample feature and a second similarity between the reference sample feature and the negative sample feature, and constructing a first loss value of the initial feature extraction model based on the first similarity and the second similarity; and performing parameter updating on the basic feature extraction layer in the initial feature extraction model based on the first loss value to obtain the first feature extraction model.

Herein, in the first training stage, the initial feature extraction model and a training sample set are acquired. The training sample set includes a plurality of image samples. When an image sample is constructed, preprocessing may be performed on an existing image sample, such as flipping, rotation, scaling, noise (such as Gaussian noise or salt-and-pepper noise) addition, image brightness or contrast changing, clipping, moving, or random line or word smearing, to obtain more abundant image samples, thereby reducing overfitting of the trained feature extraction model. Then, the following processing is performed on each image sample. The resolution of the image sample is adjusted to different degrees to obtain the fourth adjusted image (for example, with the resolution of 160*160) and the fifth adjusted image (for example, with the resolution of 224*224) of the image sample. A specific adjustment operation may refer to the foregoing adjustment operation on the preset image. Details are not described herein again.

After the resolution of the image sample is adjusted, the fourth adjusted image of the image sample is used as the reference sample (i.e., an anchor image), the fifth adjusted image of the image sample is used as the positive sample, and other image samples in the training sample set except the image sample are used as negative samples. The basic feature extraction layer in the initial feature extraction model is invoked to perform basic feature extraction on the reference sample, the positive sample, and the negative sample to obtain a reference sample feature of a reference sample, a positive sample feature of a positive sample, and a negative sample feature of a negative sample. The first similarity between the reference sample feature and the positive sample feature is acquired. For example, a distance or a cosine similarity between the reference sample feature and the positive sample feature is calculated and denoted as ƒ(x,c). In addition, the second similarity between the reference sample feature and the negative sample feature is acquired. For example, a distance or a cosine similarity between the reference sample feature and the negative sample feature is calculated and denoted as ƒ(x′, c). Finally, the first loss value of the feature extraction model is constructed based on the first similarity and the second similarity. After first loss values corresponding to the image samples are obtained, a total loss value of the initial feature extraction model shown in formula (2) may be obtained. Parameter updating is performed on the basic feature extraction layer in the initial feature extraction model based on the total loss value, and an updated initial feature extraction model is used as the first feature extraction model obtained through training in the first training stage.

$${L}_{1} = - log \frac{f ( x , c )}{{\sum }_{{x}^{′} ∈ X} f ( {x}^{′} , c )} , \qquad ( 2 )$$

where c is the reference sample feature of the reference sample, x is the positive sample feature of the positive sample, x′ is the negative sample feature of the negative sample, and X is the training sample set. The numerator part represents a similarity between positive samples, and the denominator part represents a similarity between the positive sample and the negative sample.

Since the feature extraction model includes the basic feature extraction layer, the pooling layer, the first adaptation layer, and the second adaptation layer, for training of the initial feature extraction model, parameters of the pooling layer, the first adaptation layer, and the second adaptation layer in the initial feature extraction model may be fixed, the basic feature extraction layer in the initial feature extraction model is trained, and the initial feature extraction model obtained after the basic feature extraction layer is trained is determined as the feature extraction model (i.e., the first feature extraction model) obtained in the first training stage, thereby effectively reducing the training cost of the feature extraction model, and effectively improving the training efficiency of the feature extraction model. Therefore, the image processing speed can be improved.

In some embodiments, the first adaptation layer in the first feature extraction model may be trained in the following manner to obtain the second feature extraction model: invoking the first adaptation layer in the first feature extraction model to perform feature sampling on the reference sample feature, the positive sample feature, and the negative sample feature to obtain a reference sample sampling feature, a positive sample sampling feature, and a negative sample sampling feature; acquiring a third similarity between the reference sample sampling feature and the positive sample sampling feature and a fourth similarity between the reference sample sampling feature and the negative sample sampling feature, and constructing a second loss value of the first feature extraction model based on the third similarity and the fourth similarity; and performing parameter updating on the first adaptation layer in the first feature extraction model based on the second loss value to obtain the second feature extraction model.

Herein, in the second training stage, when the feature extraction model is trained, for each image sample, the first adaptation layer in the first feature extraction model trained in the first stage is invoked to perform feature sampling on the reference sample feature, the positive sample feature, and the negative sample feature to obtain the reference sample sampling feature of the reference sample feature, the positive sample sampling feature of the positive sample feature, and the negative sample sampling feature of the negative sample feature. The third similarity between the reference sample sampling feature and the positive sample sampling feature is acquired. For example, a distance or a cosine similarity between the reference sample sampling feature and the positive sample sampling feature is calculated and denoted as ƒ(y,b). In addition, the fourth similarity between the reference sample sampling feature and the negative sample sampling feature is acquired. For example, a distance or a cosine similarity between the reference sample sampling feature and the negative sample sampling feature is calculated and denoted as ƒ(y′,b). Finally, the second loss value of the first feature extraction model is constructed based on the third similarity and the fourth similarity. After second loss values corresponding to the image samples are obtained, a total loss value of the first feature extraction model shown in formula (3) may be obtained. Parameter updating is performed on the first adaptation layer in the first feature extraction model based on the total loss value to obtain an updated first feature extraction model, and the updated first feature extraction model is used as the second feature extraction model obtained through training in the second training stage.

$${L}_{2} = - log \frac{f ( y , b )}{{\sum }_{{y}^{′} ∈ Y} f ( {y}^{′} , b )} , \qquad ( 3 )$$

where b is the reference sample sampling feature corresponding to the reference sample feature, y is the positive sample sampling feature corresponding to the positive sample feature, y′ is the negative sample sampling feature corresponding to the negative sample feature, and Y is a feature sample set. The numerator part represents a similarity between positive sample sampling features, and the denominator part represents a similarity between the positive sample sampling feature and the negative sample sampling feature.

When the first feature extraction model obtained through training in the first training stage continues to be trained, the parameters of the basic feature extraction layer, the pooling layer, and the second adaptation layer in the first feature extraction model may be fixed, the first adaptation layer in the first feature extraction model is trained, and the first feature extraction model obtained after the first adaptation layer is trained is determined as the feature extraction model (i.e., the second feature extraction model) obtained through training in the second stage, thereby effectively reducing the training cost of the feature extraction model, and effectively improving the training efficiency of the feature extraction model. Therefore, the image processing speed can be improved.

In some embodiments, the second adaptation layer in the second feature extraction model may be trained in the following manner to obtain the third feature extraction model: acquiring a feature sample set, the feature sample set including feature samples corresponding to a plurality of image samples and feature labels of the feature samples, and the feature labels being configured for indicating sampling features obtained by performing feature sampling on the feature samples through the first adaptation layer; invoking the second adaptation layer in the second feature extraction model to perform feature sampling on the feature samples to obtain prediction sampling features of the feature samples; determining similarities between the prediction sampling features of the feature samples and the sampling features indicated by the feature labels, and averaging the similarities to obtain a third loss value of the second feature extraction model; and performing parameter updating on the second adaptation layer in the second feature extraction model based on the third loss value to obtain the third feature extraction model.

Herein, the feature sample set includes the feature samples of the plurality of image samples and the feature labels of the feature samples. The feature samples include: a reference sample feature of the second adjusted image (with the resolution of 224*224) corresponding to the image sample, a positive sample feature of the first adjusted image (with the resolution of 160*160) corresponding to the image sample, and negative sample features corresponding to other image samples. The feature label is configured for indicating a sampling feature obtained by performing feature sampling on the feature sample through the first adaptation layer in the second feature extraction model.

As an example, an expression of the third loss value is shown in formula (4):

$${L}_{3} = \frac{1}{\vert D \vert} {\sum }_{i ∈ D} [ 1 - cos 〈 {ϕ}_{n e w} ( i ) , {ϕ}_{o l d} ( i ) 〉 ] , \qquad ( 4 )$$

where i is an inputted image sample, D is the feature sample set, ϕ_{old}(i) is the sampling feature obtained by performing feature sampling on the feature sample through the first adaptation layer, and ϕ_{new}(i) is a prediction sampling feature obtained by performing feature sampling on the feature sample through the second adaptation layer.

When the feature extraction model is trained, for the feature samples (including the foregoing reference sample feature, positive sample feature, and negative sample feature) in the feature sample set, the second adaptation layer in the second feature extraction model is invoked to perform feature sampling on the feature samples to obtain the prediction sampling features corresponding to the feature samples.

When the second feature extraction model obtained through training in the second training stage continues to be trained, the parameters of the basic feature extraction layer, the pooling layer, and the first adaptation layer in the second feature extraction model may be fixed, the second adaptation layer in the second feature extraction model is trained, and the second feature extraction model obtained after the second adaptation layer is trained is determined as the feature extraction model (i.e., the third feature extraction model) obtained through training in the third training stage. Since there are three training stages in total, the third feature extraction model obtained through training in the last training stage (i.e., the third training stage) is determined as a finally used feature extraction model (that is, feature extraction is performed on the first adjusted image and the second adjusted image of the preset image), thereby effectively reducing the training cost of the feature extraction model, and effectively improving the training efficiency of the feature extraction model. Therefore, the image processing speed can be improved.

In some embodiments, FIG. 3E is a fifth schematic flowchart of an AI-based image processing method according to an embodiment of the present disclosure. The acquiring first reference image features and second reference image features of reference images in a first reference image set in operation 101 in FIG. 3A may be implemented by performing operation 1011B to operation 1014B shown in FIG. 3E on the reference images in the first reference image set. Operation 1011B: Adjust a resolution of the reference image to obtain a third adjusted image of the reference image. Operation 1012B: Perform basic feature extraction on the third adjusted image of the reference image to obtain a third basic feature of the reference image. Operation 1013B: Perform pooling on the third basic feature of the reference image to obtain a third pooling feature of the reference image. Operation 1014B: Perform feature sampling of different degrees on the third pooling feature to obtain the first reference image feature and the second reference image feature of the reference image.

Herein, before feature extraction is performed on each reference image, the resolution of each reference image may be adjusted to obtain a corresponding third adjusted image. An adjustment range of the resolution is determined according to an actual situation. For example, if the reference image is an image with a resolution of 1,024*1,024, the reference image may be resampled into adjusted images with different resolutions through bilinear interpolation. For example, a third adjusted image with a resolution of 224*224 is obtained through resampling. Then, the third adjusted image is inputted into the trained feature extraction model, basic feature extraction is performed on the third adjusted image through the basic feature extraction layer to obtain the third basic feature of the reference image, and pooling is performed on the third basic feature through the pooling layer to obtain the third pooling feature (for example, a 512*7*7-dimensional feature). Finally, feature sampling of different degrees is performed on the third pooling feature. For example, feature sampling is performed on the third pooling feature through the first adaptation layer to obtain the first reference image feature (i.e., a reference image feature of a first dimension, for example, a 128*1*1-dimensional feature) of the reference image, and simple dimension reduction is performed on the third pooling feature to obtain the second reference image feature (i.e., a reference image feature of a second dimension, for example, a 512*1*1-dimensional feature) of the reference image.

In some embodiments, operation 1012B may be implemented in the following manner: performing basic feature extraction on the third adjusted image corresponding to the reference image through a neural network to obtain a plurality of feature maps of the reference image, and use the plurality of feature maps as the third basic feature. Correspondingly, operation 1013B may be implemented in the following manner: performing feature fusion on the plurality of feature maps to obtain the third pooling feature of the reference image.

As an example, assuming that the resolution of the third adjusted image is 224*224, and when the third adjusted image with the resolution of 224*224 is inputted into the trained feature extraction model for feature extraction, the third adjusted image with the resolution of 224*224 is first divided into 28*28 small regions. Each small region occupies an 8*8 pixel region, a central point is generated in the middle of each small region, each central point is located in a middle 2*2 region in each small region, that is, occupies a region size of four pixels, and each small region corresponds to a 1*1*128 part in a 28*28*128 feature map outputted by the pooling layer. Next, the numbers in each channel dimension are combined to generate a 128-dimensional feature vector to complete the generation of the 128-dimensional feature vector at each central point. Each sixteen small regions further correspond to a 1*1*512 part in a 7*7*512 feature map outputted by the pooling layer. Next, the numbers in each channel dimension are combined to generate a 512-dimensional feature vector.

In some embodiments, operation 1014B may be implemented in the following manner: acquiring a first compressed feature and a second compressed feature that are configured for compressing a feature dimension of the third pooling feature; multiplying the first compressed feature by the pooling feature of the reference image to obtain a first multiplication result, and multiplying the second compressed feature by the pooling feature of the reference image to obtain a second multiplication result; and performing non-linear transformation on the first multiplication result to obtain the first reference image feature of the reference image, and performing non-linear transformation on the second multiplication result to obtain the second reference image feature of the reference image.

As an example, an expression of the sampling features may be:

$${R}_{s q} = {f}_{s q} ( Z ) = {a}_{1} ( {W}_{s q} \cdot {Z}^{T} ) , \qquad ( 5 )$$

where R_{sq} is configured for indicating a compressed feature (for example, the first reference image feature or the second reference image feature), W_{sq} is configured for indicating a compressed feature (for example, the first compressed feature or the second compressed feature), Z^{T} is configured for indicating the third pooling feature, a₁ is configured for indicating a non-linear transformation activation function, and f_{sq} is configured for indicating a compression function.

Operation 102: Determine first matching degrees between the preset image and the reference images in the first reference image set based on the first image feature and the first reference image features of the reference images in the first reference image set, and selecting, based on the first matching degrees, a preset number of reference images from the first reference image set to generate a second reference image set.

As an example, the first image feature of the preset image is a 128*1*1-dimensional feature (i.e., the image feature of the first dimension, which may be referred to as a 128-dimensional feature for short). The first reference image set includes 10,000 reference images, and the first reference image feature of each reference image is also a 128*1*1-dimensional feature. The first image feature of the preset image is matched with the first reference image features of the reference images. For example, similarity values between the first image feature of the preset image and the first reference image features of the reference images are calculated and used as first matching degrees. In this way, 10,000 first matching degrees can be obtained. Then, the 10,000 first matching degrees are arranged in descending order. Reference images corresponding to a plurality of first matching degrees sorted top are selected from a sorting result of the first matching degrees in descending order. For example, 500 reference images whose first matching degrees exceed a matching degree threshold (which may be set according to an actual situation) are screened from the 10,000 reference images, and the 500 screened reference images form the second reference image set.

Operation 103: Determine second matching degrees between the preset image and reference images in the second reference image set based on the second image feature and second reference image features of the reference images in the second reference image set, and determine an image processing result of the preset image based on the second matching degrees.

Following the foregoing example, assuming that the second image feature of the preset image is a 512*1*1-dimensional feature, the second image feature of the preset image is matched with second reference image features (512*1*1-dimensional features) of the 500 screened reference images. For example, similarity values between the second image feature of the preset image and the second reference image features of the 500 screened reference images are calculated and used as second matching degrees. In this way, 500 second matching degrees can be obtained. In addition, the image processing result of the preset image is determined based on a sorting result of the second matching degrees in descending order (i.e., a sorting result of the 500 second matching degrees in descending order). For example, a maximum second matching degree is screened from the 500 second matching degrees, and a reference image corresponding to the screened maximum second matching degree is used as an image most similar to the preset image, that is, the preset image and the reference image corresponding to the maximum second matching degree are similar images.

In some embodiments, the resolution of the preset image and the resolution of each reference image in the first reference image set may be adjusted by the same magnitude (that is, one image is adjusted to obtain an adjusted image, for example, one reference image is adjusted to obtain an adjusted image). The resolution of the preset image and the resolution of the reference image may be the same or different. For example, the preset image and the reference image are each an image with a resolution of 1,024*1,024, and the resolution of the preset image and the resolution of the reference image are adjusted to obtain adjusted images with a resolution of 224*224. Then, in a feature extraction stage, feature extraction is performed on the adjusted image (with a resolution of 224*224) of the preset image to obtain the first image feature (i.e., the image feature of the first dimension, for example, a 128-dimensional feature vector, corresponding to the adjusted image with the resolution of 224*224) and the second image feature (i.e., the image feature of the second dimension, for example, a 512-dimensional feature vector, corresponding to the adjusted image with the resolution of 224*224) of the preset image. Feature extraction is performed on the adjusted image (with the resolution of 224*224) of the reference image to obtain a first reference image feature (i.e., the reference image feature of the first dimension, for example, the 128-dimensional feature vector, corresponding to the adjusted image with the resolution of 224*224) and a second reference image feature (i.e., the reference image feature of the second dimension, for example, the 512-dimensional feature vector, corresponding to the adjusted image with the resolution of 224*224) of a reference adjusted image. Finally, in a feature matching stage, the first image feature (corresponding to the first dimension, for example, the 128-dimensional feature vector, corresponding to the adjusted image with the resolution of 224*224) of the preset image is first matched with the first reference image features (corresponding to the first dimension, for example, the 128-dimensional feature vector, corresponding to the adjusted image with the resolution of 224*224) of the reference images in the first reference image set to obtain the first matching degrees, and a plurality of reference images sorted top are selected from the sorting result of the first matching degrees in descending order. For example, 500 reference images whose first matching degrees exceed the matching degree threshold are screened from the 10,000 reference images, and the 500 screened reference images form the second reference image set. Then, the second image feature (corresponding to the second dimension, for example, the 512-dimensional feature vector, corresponding to the adjusted image with the resolution of 224*224) of the preset image is matched with the second reference image features (corresponding to the second dimension, for example, the 512-dimensional feature vector, corresponding to the adjusted image with the resolution of 224*224) of the reference images in the second reference image set to obtain the second matching degrees, and the image processing result of the preset image is determined according to the sorting result of the second matching degrees in descending order. For example, a reference image with the maximum second matching degree is used as the image most similar to the preset image, that is, the preset image and the reference image corresponding to the maximum second matching degree are similar images.

In other embodiments, the preset image and each reference image in the first reference image set may further be adjusted by different amplitudes (that is, one image is adjusted to obtain two adjusted images). The resolution of the preset image and the resolution of the reference image may be the same or different. For example, a preset image with the resolution of 1024*1024 is adjusted to obtain an adjusted image (i.e., the first adjusted image) with the resolution of 160*160 and an adjusted image (i.e., the second adjusted image) with the resolution of 224*224. A reference image with the resolution of 1024*1024 is similarly adjusted to obtain an adjusted image with the resolution of 160*160 and an adjusted image with the resolution of 224*224. In the feature extraction stage, for the 160*160 adjusted image of the preset image, a first image feature (i.e., the image feature of the first dimension, for example, the 128-dimensional feature vector, corresponding to the adjusted image with the resolution of 160*160) is extracted, and for the 224*224 adjusted image of the preset image, a second image feature (for example, the 512-dimensional feature vector, corresponding to the adjusted image with the resolution of 224*224) is extracted. For the 160*160 adjusted image of the reference image, a first reference image feature (i.e., the reference image feature of the first dimension, for example, the 128-dimensional feature vector, corresponding to the adjusted image with the resolution of 160*160) is extracted, and for the 224*224 adjusted image of the reference image, a second reference image feature (i.e., the reference image feature of the second dimension, for example, the 512-dimensional feature vector, corresponding to the adjusted image with the resolution of 224*224) is extracted. In the feature matching stage, the first image feature (corresponding to the first dimension, for example, the 128-dimensional feature vector, corresponding to the adjusted image with the resolution of 160*160) of the preset image is first matched with the first reference image features (corresponding to the first dimension, for example, the 128-dimensional feature vector, corresponding to the adjusted image with the resolution of 160*160) of the reference images in the first reference image set to obtain the first matching degrees, and a plurality of reference images sorted top are selected from the sorting result of the first matching degrees in descending order. For example, 500 reference images whose first matching degrees exceed the matching degree threshold are screened from the 10,000 reference images, and the 500 screened reference images form the second reference image set. Then, the second image feature (corresponding to the second dimension, for example, the 512-dimensional feature vector, corresponding to the adjusted image with the resolution of 224*224) of the preset image is matched with the second reference image features (corresponding to the second dimension, for example, the 512-dimensional feature vector, corresponding to the adjusted image with the resolution of 224*224) of the reference images in the second reference image set to obtain the second matching degrees, and the image processing result of the preset image is determined according to the sorting result of the second matching degrees in descending order. For example, a reference image with the maximum second matching degree is used as the image most similar to the preset image, that is, the preset image and the reference image corresponding to the maximum second matching degree are similar images.

In the foregoing manner, since the adjusted images of a relatively small dimension are adjusted from the original preset image and the reference image, the calculation amount of subsequent feature extraction and feature matching may be reduced based on the adjusted images.

After a retrieval result of the preset image is determined, the preset image may be reviewed based on the retrieval result. If it is determined, based on the retrieval result, that the preset image is a low-quality image, a corresponding masking mode is adopted for the preset image belonging to the low-quality image. For example, in a recall process of a recommendation system, low-quality images are temporarily or permanently filtered, and filtered low-quality images are sorted. In a sorting process of the recommendation system, weight-reducing sorting is performed on the low-quality images. Therefore, a high-quality image is recommended to a terminal for displaying, thereby avoiding the wide spread of the low-quality images, indirectly improving the overall image quality, improving the user experience, and effectively reserving new users and returning users.

Exemplary application of this embodiment of the present disclosure in an actual application scene will be described below. An image content review system needs to perform matching review on a preset image uploaded by a user and diversified images (i.e., reference images) in a base library (i.e., the foregoing first reference image set). The entire image content review system faces a very large volume of retrieval data and base library data. In addition, the image content review system is relatively sensitive to the image processing performance and aims to improve the retrieval speed as much as possible without reducing the retrieval performance.

According to the AI-based image processing method provided in the embodiments of the present disclosure, the image processing performance may be effectively improved without increasing the matching calculation amount in an image processing process so that the image content review system may be more easily deployed in various application scenes to implement image matching and interception on various types of sensitive content.

As shown in FIG. 4, the feature extraction model provided in this embodiment of the present disclosure includes a basic feature extraction layer, a pooling layer, a first adaptation layer, and a second adaptation layer. The basic feature extraction layer may be considered as a convolution layer configured to extract features. The pooling layer adopts a generalized average pooling policy to acquire the differentiation and correlation between the basic features extracted through the basic feature extraction layer. The first adaptation layer and the second adaptation layer may each be a fully-connected network or a multilayer perceptron network. The number of network layers may be set according to an actual requirement to extract low-dimensional features satisfying the requirement. The first adaptation layer and the second adaptation layer are configured to perform dimension reduction on pooling features outputted by the pooling layer to perform matching calculation on low-dimension image features obtained through dimension reduction so that the time consumption of matching calculation can be reduced, thereby improving the image processing efficiency.

In actual application, an output dimension of the basic feature extraction layer in the feature extraction model may be set according to an actual requirement, for example, set to 512 dimensions. Based on locking the basic feature extraction layer, adaptation layers, such as the first adaptation layer and the second adaptation layer, configured to perform feature dimension reduction (for example, mapping a 512-dimensional feature to 128 dimensions) on a pooling result are added after the pooling layer. The number of network layers of the fully-connected network or the multilayer perceptron network in the first adaptation layer and the second adaptation layer may be set according to an actual requirement.

For example, assuming that when the feature extraction model is trained, the first adaptation layer is configured to acquire an image feature of a first dimension (for example, a 128*1*1-dimensional feature, corresponding to an adjusted image with a resolution of 224*224) of a fifth adjusted image corresponding to an image sample, and the second adaptation layer is configured to acquire an image feature of a first dimension (for example, a 128*1*1-dimensional feature, corresponding to an adjusted image with a resolution of 160*160) of a fourth adjusted image corresponding to the image sample. Assuming that a resolution of each reference image in the base library configured for matching is 224*224, a reference image feature of a first dimension (i.e., a first reference image feature) corresponding to the reference image is a 128*1*1-dimensional feature, and a reference image feature of a second dimension (i.e., a second reference image feature) is a 512*1*1-dimensional feature, after the resolution of the preset image is adjusted by different amplitudes to generate a first adjusted image (with the resolution of 160*160) and a second adjusted image (with the resolution of 224*224), when feature extraction is performed on the first adjusted image and the second adjusted image, the basic feature extraction layer and the pooling layer in the feature extraction model may be shared. That is, after the first adjusted image is processed by the basic feature extraction layer and the pooling layer to output a 512*4*4-dimensional feature, and the second adjusted image is processed by the basic feature extraction layer and the pooling layer to output a 512*7*7-dimensional feature.

However, since a difference between the first adjusted image (with the resolution of 160*160) and the reference image (with the resolution of 224*224) is greater than a difference between the second adjusted image (with the resolution of 224*224) and the reference image (with the resolution of 224*224), when feature sampling is performed on a pooling feature corresponding to the first adjusted image (with the resolution of 160*160) of the preset image, the second adaptation layer with a relatively complex structure (for example, the second adaptation layer is of a spindle-shaped structure including two fully-connected layers) may be adopted to perform feature sampling to obtain the image feature of the first dimension (i.e., a first image feature, for example, a 128*1*1-dimensional feature) of the first adjusted image. When feature sampling is performed on the second pooling feature of the second adjusted image (with the resolution of 224*224), dimension reduction may be performed on a second pooling feature of the second adjusted image to obtain the image feature of the second dimension (i.e., a second image feature, for example, a 512*1*1-dimensional feature, corresponding to the second adjusted image with the resolution of 224*224) of the second adjusted image. When the image feature of the first dimension (i.e., the first image feature, for example, a 128*1*1-dimensional feature, corresponding to the second adjusted image with the resolution of 224*224) of the second adjusted image needs to be acquired, the first adaptation layer with a relatively simple structure (for example, the first adaptation layer includes a fully-connected layer) may be adopted to perform feature sampling to obtain the image feature of the first dimension (i.e., the first image feature, for example, a 128*1*1-dimensional feature, corresponding to the second adjusted image with the resolution of 224*224) of the second adjusted image.

Next, a training process of the feature extraction model is described. When the feature extraction model is trained, the feature extraction model may be trained in three training stages.

1) First stage: train the basic feature extraction layer.

When the feature extraction model is trained, an initial feature extraction model may be trained to obtain a first feature extraction model, and structures of the initial feature extraction model and the first feature extraction model are the same. During training, the initial feature extraction model and a training sample set are acquired. The training sample set includes a plurality of image samples, and the following processing is performed on each image sample. The resolution of the image sample is adjusted by different amplitudes to obtain a fourth adjusted image and a fifth adjusted image of the image sample. For example, an image sample with a resolution of 1,024*1,024 is resampled into adjusted images with different resolutions through bilinear interpolation. For example, a fourth adjusted image with a resolution of 160*160 and a fifth adjusted image with a resolution of 224*224 are obtained through resampling.

After the image sample is adjusted, the fourth adjusted image of the image sample is used as a reference sample (i.e., an anchor image), the fifth adjusted image of the image sample is used as a positive sample, and other image samples in the training sample set except the image sample are used as negative samples. The basic feature extraction layer in the initial feature extraction model is invoked to perform basic feature extraction on the reference sample, the positive sample, and the negative sample to obtain a corresponding reference sample feature, positive sample feature, and negative sample feature. A first similarity between the reference sample feature and the positive sample feature and a second similarity between the reference sample feature and the negative sample feature are acquired, and a loss value of the initial feature extraction model is constructed based on the first similarity and the second similarity. After loss values corresponding to the image samples are obtained, a total loss value of the initial feature extraction model may be obtained. Parameter updating is performed on the basic feature extraction layer in the initial feature extraction model based on the total loss value, and an updated initial feature extraction model is used as the first feature extraction model obtained through training in the first training stage.

The total loss value of the initial feature extraction model may be represented as:

$${L}_{1} = - log \frac{f ( x , c )}{{\sum }_{{x}^{′} ∈ X} f ( {x}^{′} , c )} ,$$

where c is the reference sample feature corresponding to the reference sample, x is the positive sample feature corresponding to the positive sample, x′ is the negative sample feature corresponding to the negative sample, and X is the training sample set. The numerator part represents the first similarity between positive samples, and the denominator part represents the second similarity between the positive sample and the negative sample. Through the foregoing expression, a distance between a reference sample and an adjusted sample (i.e., the positive sample) of the reference sample may be shortened, and distances between the reference sample and remaining samples (i.e., the negative samples) may be increased.

In the foregoing manner, when the initial feature extraction model is trained, parameters of the pooling layer, the first adaptation layer, and the second adaptation layer in the initial feature extraction model are fixed, the basic feature extraction layer in the initial feature extraction model is trained, and the initial feature extraction model obtained after the basic feature extraction layer is trained is determined as the first feature extraction model obtained in the first training stage, thereby effectively reducing the training cost of the feature extraction model, and effectively improving the training efficiency of the feature extraction model. Therefore, the image processing speed can be improved.

2) Second stage: train the first adaptation layer.

An example in which the first adaptation layer includes a fully-connected layer is used. When the first adaptation layer in the feature extraction model is trained, training is performed using a loss function the same as that used when the basic feature extraction layer is trained in the first stage. For example, during training, for each image sample (with the resolution of 224*224), the first adaptation layer in the first feature extraction model obtained in the first training stage is invoked to perform feature sampling on the reference sample feature, the positive sample feature, and the negative sample feature of the image sample to obtain a reference sample sampling feature, a positive sample sampling feature, and a negative sample sampling feature. A third similarity between the reference sample sampling feature and the positive sample sampling feature and a fourth similarity between the reference sample sampling feature and the negative sample sampling feature are acquired, and a second loss value of the first feature extraction model is constructed based on the third similarity and the fourth similarity. After second loss values corresponding to the image samples are obtained, a total loss value of the first feature extraction model may be obtained. Parameter updating is performed on the first adaptation layer in the first feature extraction model based on the total loss value, and an updated first feature extraction model is used as a second feature extraction model obtained through training in the second training stage.

The total loss value of the first feature extraction model may be represented as:

$${L}_{2} = - log \frac{f ( y , b )}{{\sum }_{{y}^{′} ∈ Y} f ( {y}^{′} , b )} ,$$

where b is the reference sample sampling feature corresponding to the reference sample feature, y is the positive sample sampling feature corresponding to the positive sample feature, y′ is the negative sample sampling feature corresponding to the negative sample feature, and Y is a feature sample set. The numerator part represents a similarity between positive sample sampling features, and the denominator part represents a similarity between the positive sample sampling feature and the negative sample sampling feature.

In the foregoing manner, when the first feature extraction model obtained through training in the first training stage continues to be trained, the parameters of the basic feature extraction layer, the pooling layer, and the second adaptation layer in the first feature extraction model are fixed, the first adaptation layer in the first feature extraction model is trained, and the first feature extraction model obtained after the first adaptation layer is trained is determined as the feature extraction model (i.e., the second feature extraction model) obtained through training in the second training stage, thereby effectively reducing the training cost of the feature extraction model, and effectively improving the training efficiency of the feature extraction model. Therefore, the image processing speed can be improved.

3) Third stage: train the second adaptation layer.

An example in which the second adaptation layer is of a spindle-shaped structure including two fully-connected layers is used. When the second adaptation layer is trained, the second feature extraction model obtained in the second training stage and the feature sample set are acquired. The feature sample set includes feature samples corresponding to a plurality of image samples. For a fourth adjusted image (for example, with the resolution of 160*160) of each image sample, a second adaptation layer in the second feature extraction model is invoked to perform feature sampling on the feature samples to obtain prediction sampling features corresponding to the feature samples. Similarities between the prediction sampling features of the feature samples and the feature labels are determined and averaged to obtain a third loss value of the second feature extraction model. Parameter updating is performed on the second adaptation layer in the second feature extraction model based on the third loss value, and an updated second feature extraction model is used as a third feature extraction model obtained through training in the third training stage.

During training in the third stage, the resolution of the adjusted image in the second stage is reduced from 224*224 to 160*160 to reduce the calculation amount in the initial screening stage. The calculation amount of the model is approximately proportional to the square of the length and the width of the input image. Using 160*160 as the input size may reduce the calculation amount by approximately 50% for a large number of retrieved images.

Herein, the feature sample set includes feature samples corresponding to a plurality of image samples and feature labels corresponding to the feature samples, and the feature labels are configured for indicating sampling features obtained by performing feature sampling on the feature samples through the first adaptation layer.

As an example, an expression of the third loss value may be:

$${L}_{3} = \frac{1}{\vert D \vert} {\sum }_{i ∈ D} [ 1 - cos 〈 {ϕ}_{n e w} ( i ) , {ϕ}_{o l d} ( i ) 〉 ] ,$$

where i is an inputted image sample, D is the feature sample set, ϕ_{old}(i) is the sampling feature obtained by performing feature sampling on the feature sample through the first adaptation layer, and ϕ_{new}(i) is the prediction sampling feature obtained by performing feature sampling on the feature sample through the second adaptation layer.

In the foregoing manner, when the second feature extraction model obtained through training in the second training stage continues to be trained, the parameters of the basic feature extraction layer, the pooling layer, and the first adaptation layer in the second feature extraction model may be fixed, the second adaptation layer in the second feature extraction model is trained, and the second feature extraction model obtained after the second adaptation layer is trained is determined as the feature extraction model (i.e., the third feature extraction model, i.e., the finally used feature extraction model) obtained through training in the third training stage, thereby effectively reducing the training cost of the feature extraction model, and effectively improving the training efficiency of the feature extraction model. Therefore, the image processing speed can be improved.

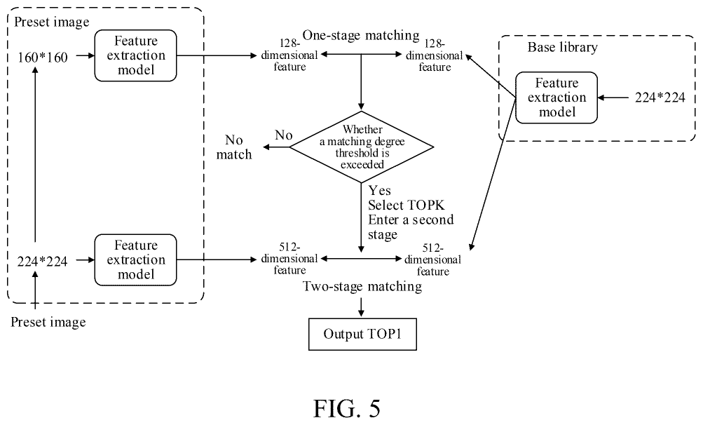

After the training of the feature extraction model is completed, image processing may be performed based on the feature extraction model. FIG. 5 is a schematic flowchart of AI-based image processing according to an embodiment of the present disclosure. First, for a large number of reference images in a base library, resolutions of the reference images are adjusted to obtain third adjusted images of the reference images. For example, a reference image with a resolution of 1,024*1,024 is resampled through bilinear interpolation to obtain a third adjusted image with a resolution of 224*224. Then, the third adjusted image is inputted into the trained feature extraction model for feature extraction. For example, basic feature extraction is performed on the third adjusted image through the basic feature extraction layer to obtain a third basic feature of the reference image, and pooling is performed on the third basic feature through the pooling layer to obtain a third pooling feature. Feature sampling is performed on the third pooling feature through the first adaptation layer to obtain a reference image feature of a first dimension (i.e., a first reference image feature, for example, a 128*1*1-dimensional feature) of the reference image, and simple dimension reduction is performed on the third pooling feature to obtain a reference image feature of a second dimension (i.e., a second reference image feature, for example, a 512*1*1-dimensional feature) of the reference image. In addition, the first reference image feature (for example, the 128*1*1-dimensional feature) and the second reference image feature (for example, the 512*1*1-dimensional feature) of each reference image are recorded in the base library.

Then, feature extraction and matching are performed on the preset image. In actual application, the feature extraction and matching may be performed in two stages and described one by one next.

a) First stage: a resolution of a preset image is first adjusted by different amplitudes to obtain a first adjusted image and a second adjusted image of the preset image. For example, a preset image with the resolution of 1,024*1,024 is resampled through bilinear interpolation to obtain adjusted images of different resolutions. For example, a first adjusted image with the resolution of 160*160 and a second adjusted image with the resolution of 224*224 are obtained through resampling. Then, the first adjusted image (with the resolution of 160*160) is inputted into the trained feature extraction model for feature extraction. For example, basic feature extraction is performed on the first adjusted image (with the resolution of 160*160) through the basic feature extraction layer to obtain a first basic feature (for example, a 512*4*4-dimensional feature), pooling is performed on the first basic feature through the pooling layer to obtain a first pooling feature, and feature sampling is performed on the first pooling feature through the second adaptation layer to obtain an image feature of a first dimension (i.e., a first image feature, for example, a 128*1*1-dimensional feature, corresponding to the inputted first adjusted image with the resolution of 160*160). Meanwhile, the second adjusted image (with the resolution of 224*224) is inputted into the trained feature extraction model for feature extraction. For example, basic feature extraction is performed on the second adjusted image (with the resolution of 224*224) through the basic feature extraction layer to obtain a second basic feature (for example, a 512*7*7-dimensional feature), pooling is performed on the second basic feature through the pooling layer to obtain a second pooling feature, and simple dimension reduction is performed on the second pooling feature to obtain an image feature of a second dimension (i.e., a second image feature, for example, a 512*1*1-dimensional feature, corresponding to the inputted second adjusted image with the resolution of 224*224).

Then, the first image feature (corresponding to the first dimension, i.e., the 128*1*1-dimensional feature corresponding to the first adjusted image with the resolution of 160*160) of the preset image is matched with first reference image features (corresponding to the first dimension, for example, 128*1*1-dimensional features) of the reference images in the base library to obtain first matching degrees between the preset image and the reference images in the base library. Whether the first matching degrees exceed a matching degree threshold (which may be set according to an actual requirement) is determined. When the first matching degrees do not exceed the matching degree threshold, there is no matching item. When the first matching degrees exceed the matching degree threshold, reference images corresponding to the first matching degrees that exceed the matching degree threshold are selected. That is, a plurality of reference images sorted tops (for example, TOPK, where K is a positive integer) are selected from a sorting result of the first matching degrees in descending order. For example, the base library includes 10,000 reference images, 500 reference images whose first matching degrees exceed the matching degree threshold are selected from the base library, and the 500 selected reference images are used for subsequent secondary matching.

b) Second stage: the second image feature (corresponding to the second dimension, i.e., the 512*1*1-dimensional feature corresponding to the second adjusted image with the resolution of 224*224) of the preset image is matched with second reference image features (corresponding to the second dimension, for example, 512*1*1-dimensional features) of the reference images selected in the first stage to obtain second matching degrees between the preset image and the selected reference images. For example, similarity values between the second image feature (512*1*1-dimensional feature) of the preset image and the second reference image features (512*1*1-dimensional features) of a plurality of selected reference images are calculated and used as the second matching degrees, and an image processing result of the preset image is determined based on a sorting result of the second matching degrees in descending order. For example, a reference image with a maximum second matching degree (i.e., TOP1 in the sorting result of the second matching degrees in descending order) is used as an image most similar to the preset image, that is, the preset image and the reference image corresponding to the maximum second matching degree are similar images.

In the foregoing manner, in this embodiment of the present disclosure, a two-stage solution is used. During first-stage matching, a particular number of reference images are first screened through matching of low-dimensional image features of low-resolution images, which can reduce the matching time consumption required for processing a large number of images, thereby improving the image processing efficiency. Specifically, as shown in Table 1, when matching is performed on the 512*1*1-dimensional feature corresponding to the image with the resolution of 224*224, in a T4 GPU environment, the queries-per-second (QPS) is 1567. When matching is performed on the 512*1*1-dimensional feature corresponding to the image with the resolution of 160*160, in the same T4 GPU environment, the QPS is 3294, with a speed increase of more than 100%.

TABLE 1

| Image resolution | QPS in T4 GPU environment |
|---|---|
| 224*224 | 1567 |
| 160*160 | 3294 |

In addition, when feature sampling (or dimension reduction) is performed on the pooling features, different adaptation layers (i.e., the first adaptation layer and the second adaptation layer, denoted as FC1-FC2) are adopted for asymmetric feature sampling. In addition, when matching is performed based on sampled features, the matching calculation amount can be greatly reduced on the premise that the recall rate is at a considerable level and a detection missing rate is controllable. Specifically, as shown in Table 2, when only features extracted from the second adaptation layer (FC1) are used for matching, the recall rate is 94.53%, and the detection missing rate is five in one hundred thousand. When features extracted from the asymmetric adaptation layers (FC1-FC2) are used for matching, the recall rate is 94.51%, and the detection missing rate is three in ten thousand, but the matching calculation amount is reduced to 60%, which reduces the matching time consumption required for retrieving a large number of images, thereby improving the image retrieval efficiency.

TABLE 2

| | | Matching calculation |
|---|---|---|
| Retrieval structure | Recall rate | amount |
| FC1 | 94.53% | 1 |
| FC1-FC2 | 94.51% | Reduction by 60% |

In addition, during the second-stage matching, for a relatively small number of screened reference images, matching is performed using high-dimensional image features to determine the image processing result. The high-dimensional image feature can capture more detailed and complex information in the preset image and characterize more abundant information content. Therefore, when the preset image is processed according to a high-dimensional feature with abundant information, information such as a texture, a shape, a color, and a structure of the preset image may be described more comprehensively, and the image processing accuracy can be ensured.

The AI-based image processing method provided in the embodiments of the present disclosure is described with reference to exemplary application and implementations of the electronic device provided in the embodiments of the present disclosure. The following continues to describe the cooperation of modules in an AI-based image processing apparatus 255 provided in this embodiment of the present disclosure to implement an AI-based image processing solution.

An acquisition module 2551 is configured to acquire a first image feature and a second image feature of a preset image, and first reference image features and second reference image features of reference images in a first reference image set, a dimension of the first image feature and a dimension of each of the first reference image features being the same, a dimension of the second image feature and a dimension of each of the second reference image features being the same, and the dimension of the first image feature being less than the dimension of the second image feature. A screening module 2552 is configured to determine first matching degrees between the preset image and the reference images in the first reference image set based on the first image feature and the first reference image features of the reference images in the first reference image set, and selecting, based on the first matching degrees, a preset number of reference images from the first reference image set to generate a second reference image set. A determining module 2553 is configured to determine second matching degrees between the preset image and reference images in the second reference image set based on an image feature of a second dimension and second reference image features of the reference images in the second reference image set, and determine an image processing result of the preset image based on the second matching degrees.

In some embodiments, the acquisition module is further configured to adjust a resolution of the preset image to obtain a first adjusted image and a second adjusted image of the preset image; and perform feature extraction on the first adjusted image and the second adjusted image of the preset image to obtain the first image feature and the second image feature of the preset image.

In some embodiments, the acquisition module is further configured to perform basic feature extraction on the first adjusted image and the second adjusted image of the preset image to obtain a first basic feature and a second basic feature; perform pooling on the first basic feature and the second basic feature to obtain a first pooling feature and a second pooling feature; and perform feature sampling on the first pooling feature and the second pooling feature to obtain an image feature of a first dimension and an image feature of a second dimension of the preset image.

In some embodiments, the performing feature extraction on the first adjusted image and the second adjusted image is implemented by invoking a feature extraction model, and the feature extraction model includes a basic feature extraction layer, a pooling layer, and a second adaptation layer. The acquisition module is further configured to perform basic feature extraction on the first adjusted image and the second adjusted image through the basic feature extraction layer to obtain the first basic feature and the second basic feature; perform pooling on the first basic feature and the second basic feature through the pooling layer to obtain the first pooling feature and the second pooling feature; perform feature sampling on the first pooling feature through the second adaptation layer to obtain the first image feature of the preset image; and perform feature dimension reduction on the second pooling feature to obtain the second image feature of the preset image.

In some embodiments, the feature extraction model further includes a first adaptation layer, and the apparatus further includes: a model training module configured to acquire an initial feature extraction model and an image sample; train a basic feature extraction layer in the initial feature extraction model based on the image sample to obtain a first feature extraction model; freeze a parameter of a basic feature extraction layer in the first feature extraction model, and train a first adaptation layer in the first feature extraction model to obtain a second feature extraction model; and freeze the parameter of the basic feature extraction layer in the first feature extraction model and a parameter of a first adaptation layer in the second feature extraction model, train a second adaptation layer in the second feature extraction model to obtain a third feature extraction model, and use the third feature extraction model as the feature extraction model.

In some embodiments, the model training module is further configured to adjust a resolution of the image sample to obtain a fourth adjusted image and a fifth adjusted image of the image sample, use the fourth adjusted image of the image sample as a reference sample, use the fifth adjusted image of the image sample as a positive sample, and use other image samples as negative samples; invoke the basic feature extraction layer in the initial feature extraction model to perform basic feature extraction on the reference sample, the positive sample, and the negative sample to obtain a reference sample feature, a positive sample feature, and a negative sample feature; acquire a first similarity between the reference sample feature and the positive sample feature and a second similarity between the reference sample feature and the negative sample feature, and construct a first loss value of the initial feature extraction model based on the first similarity and the second similarity; and perform parameter updating on the basic feature extraction layer in the initial feature extraction model based on the first loss value to obtain the first feature extraction model.

In some embodiments, the model training module is further configured to invoke the first adaptation layer in the first feature extraction model to perform feature sampling on the reference sample feature, the positive sample feature, and the negative sample feature to obtain a reference sample sampling feature, a positive sample sampling feature, and a negative sample sampling feature; acquire a third similarity between the reference sample sampling feature and the positive sample sampling feature and a fourth similarity between the reference sample sampling feature and the negative sample sampling feature, and construct a second loss value of the first feature extraction model based on the third similarity and the fourth similarity; and perform parameter updating on the first adaptation layer in the first feature extraction model based on the second loss value to obtain the second feature extraction model.

In some embodiments, the model training module is further configured to acquire a feature sample set, the feature sample set including feature samples of a plurality of image samples and feature labels of the feature samples, and the feature labels being configured for indicating sampling features obtained by performing feature sampling on the feature samples through the first adaptation layer; invoke the second adaptation layer in the second feature extraction model to perform feature sampling on the feature samples to obtain prediction sampling features of the feature samples; determine similarities between the prediction sampling features of the feature samples and the sampling features indicated by the feature labels, and average the similarities to obtain a third loss value of the second feature extraction model; and perform parameter updating on the second adaptation layer in the second feature extraction model based on the third loss value to obtain the third feature extraction model.

In some embodiments, the acquisition module is further configured to perform the following processing on the reference images in the first reference image set: adjusting a resolution of the reference image to obtain a third adjusted image of the reference image; performing basic feature extraction on the third adjusted image of the reference image to obtain a third basic feature of the reference image; performing pooling on the third basic feature of the reference image to obtain a third pooling feature of the reference image; and performing feature sampling of different degrees on the third pooling feature to obtain the first reference image feature and the second reference image feature of the reference image.

In some embodiments, the acquisition module is further configured to perform basic feature extraction on the third adjusted image corresponding to the reference image through a neural network to obtain a plurality of feature maps of the reference image, and use the plurality of feature maps as the third basic feature; and perform feature fusion on the plurality of feature maps to obtain the third pooling feature of the reference image.

In some embodiments, the acquisition module is further configured to acquire a first compressed feature and a second compressed feature that are configured for compressing a feature dimension of the third pooling feature; multiply the first compressed feature by the third pooling feature to obtain a first multiplication result, and multiply the second compressed feature by the third pooling feature to obtain a second multiplication result; and perform non-linear transformation on the first multiplication result to obtain the first reference image feature of the reference image, and perform non-linear transformation on the second multiplication result to obtain the second reference image feature of the reference image.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The embodiments of the present disclosure provide a computer program product. The computer program product includes a computer program or a computer-executable instruction. The computer program or the computer-executable instruction is stored in a computer-readable storage medium. A processor of an electronic device reads the computer-executable instruction from the computer-readable storage medium and executes the computer-executable instruction to cause the electronic device to perform the AI-based image processing method provided in the embodiments of the present disclosure.

The embodiments of the present disclosure provide a computer-readable storage medium, having a computer-executable instruction stored therein. The computer-readable storage medium has a computer-executable instruction or a computer program stored therein. When the computer-executable instruction or the computer program is executed by a processor, the processor is enabled to perform the AI-based image processing method provided in the embodiments of the present disclosure, for example, the AI-based image processing method shown in FIG. 3A.

In some embodiments, the computer-readable storage medium may be a memory such as a ferroelectric RAM (FRAM), a ROM, a programmable ROM (PROM), an erasable programmable ROM (EPROM), an electrically erasable programmable ROM (EEPROM), a flash memory, a magnetic surface memory, a CD, or a CD-ROM. The computer-readable storage medium may alternatively be a device including one or any combination of the foregoing memories.

In some embodiments, the computer-executable instruction may be written in the form of program, software, software module, script, or code in any form of programming language (including compilation or interpretation language, or declarative or procedural language), and may be deployed in any form, including being deployed as an independent program or being deployed as a module, component, subroutine, or another unit suitable for use in a computing environment.

As an example, the computer-executable instruction may but may not necessarily correspond to a file in a file system, may be stored in a part of the file for storing other programs or data, for example, stored in one or more scripts in a hyper text markup language (HTML) document, stored in a single file dedicated to the discussed program, or stored in a plurality of collaborative files (for example, files storing one or more modules, a subprogram, or a code part).

As an example, the computer-executable instruction may be deployed to be executed on one electronic device, on a plurality of electronic devices located at one location, or on a plurality of electronic devices distributed at a plurality of locations and interconnected through a communication network.

The foregoing descriptions are merely embodiments of the present disclosure and are not intended to limit the protection scope of the present disclosure. Any modification, equivalent replacement, or improvement made within the spirit and scope of the present disclosure falls within the protection scope of the present disclosure.

What is claimed is:

1. An artificial intelligence (AI)-based image processing method, performed by an electronic device, the method comprising:
acquiring a first image feature and a second image feature of a preset image, and first reference image features and second reference image features of reference images in a first reference image set, a dimension of the first image feature and a dimension of each of the first reference image features being the same, a dimension of the second image feature and a dimension of each of the second reference image features being the same, and the dimension of the first image feature being less than the dimension of the second image feature;
determining first matching degrees between the preset image and the reference images in the first reference image set based on the first image feature and the first reference image features of the reference images in the first reference image set;
selecting, based on the first matching degrees, a preset number of reference images from the first reference image set to generate a second reference image set;
determining second matching degrees between the preset image and reference images in the second reference image set based on the second image feature and second reference image features of the reference images in the second reference image set; and
determining an image processing result of the preset image based on the second matching degrees.

2. The method according to claim 1, wherein the acquiring a first image feature and a second image feature of a preset image comprises:
adjusting a resolution of the preset image to obtain a first adjusted image and a second adjusted image of the preset image; and
performing feature extraction on the first adjusted image and the second adjusted image respectively to obtain the first image feature and the second image feature of the preset image.

3. The method according to claim 2, wherein the performing feature extraction on the first adjusted image and the second adjusted image to obtain the first image feature and the second image feature of the preset image comprises:
performing basic feature extraction on the first adjusted image and the second adjusted image respectively to obtain a first basic feature and a second basic feature;
performing pooling on the first basic feature and the second basic feature respectively to obtain a first pooling feature and a second pooling feature; and
performing feature sampling on the first pooling feature and the second pooling feature to obtain the first image feature and the second image feature of the preset image.

4. The method according to claim 2, wherein the performing feature extraction on the first adjusted image and the second adjusted image is implemented by invoking a feature extraction model, and the feature extraction model comprises a basic feature extraction layer, a pooling layer, and a second adaptation layer; and
the performing feature extraction on the first adjusted image and the second adjusted image to obtain the first image feature and the second image feature of the preset image comprises:
performing basic feature extraction on the first adjusted image and the second adjusted image through the basic feature extraction layer to obtain the first basic feature and the second basic feature;
performing pooling on the first basic feature and the second basic feature through the pooling layer to obtain the first pooling feature and the second pooling feature;
performing feature sampling on the first pooling feature through the second adaptation layer to obtain the first image feature of the preset image; and
performing feature dimension reduction on the second pooling feature to obtain the second image feature of the preset image.

5. The method according to claim 4, wherein the feature extraction model further comprises a first adaptation layer, and the method further comprises:
acquiring an initial feature extraction model and an image sample;
training a basic feature extraction layer in the initial feature extraction model based on the image sample to obtain a first feature extraction model;
freezing a parameter of a basic feature extraction layer in the first feature extraction model, and training a first adaptation layer in the first feature extraction model to obtain a second feature extraction model; and
freezing the parameter of the basic feature extraction layer in the first feature extraction model and a parameter of the first adaptation layer in the first feature extraction model, training a second adaptation layer in the second feature extraction model to obtain a third feature extraction model, and using the third feature extraction model as the feature extraction model.

6. The method according to claim 5, wherein the training a basic feature extraction layer in the initial feature extraction model based on the image sample to obtain a first feature extraction model comprises:
adjusting a resolution of the image sample to obtain a fourth adjusted image and a fifth adjusted image of the image sample, using the fourth adjusted image as a reference sample, using the fifth adjusted image as a positive sample, and using other image samples as negative samples;
invoking the basic feature extraction layer in the initial feature extraction model to perform basic feature extraction on the reference sample, the positive sample, and the negative sample to obtain a reference sample feature, a positive sample feature, and a negative sample feature;
acquiring a first similarity between the reference sample feature and the positive sample feature and a second similarity between the reference sample feature and the negative sample feature, and constructing a first loss value of the initial feature extraction model based on the first similarity and the second similarity; and
performing parameter updating on the basic feature extraction layer in the initial feature extraction model based on the first loss value to obtain the first feature extraction model.

7. The method according to claim 5, wherein the training a first adaptation layer in the first feature extraction model to obtain a second feature extraction model comprises:
invoking the first adaptation layer in the first feature extraction model to perform feature sampling on the reference sample feature, the positive sample feature, and the negative sample feature to obtain a reference sample sampling feature, a positive sample sampling feature, and a negative sample sampling feature;
acquiring a third similarity between the reference sample sampling feature and the positive sample sampling feature and a fourth similarity between the reference sample sampling feature and the negative sample sampling feature, and constructing a second loss value of the first feature extraction model based on the third similarity and the fourth similarity; and
performing parameter updating on the first adaptation layer in the first feature extraction model based on the second loss value to obtain the second feature extraction model.

8. The method according to claim 5, wherein the training a second adaptation layer in the second feature extraction model to obtain a third feature extraction model comprises:
acquiring a feature sample set, the feature sample set comprising feature samples corresponding to a plurality of image samples and feature labels of the feature samples, and the feature labels being configured for indicating sampling features obtained by performing feature sampling on the feature samples through the first adaptation layer;
invoking the second adaptation layer in the second feature extraction model to perform feature sampling on the feature samples to obtain prediction sampling features of the feature samples;
determining similarities between the prediction sampling features of the feature samples and the sampling features indicated by the feature labels, and averaging the similarities to obtain a third loss value of the second feature extraction model; and
performing parameter updating on the second adaptation layer in the second feature extraction model based on the third loss value to obtain the third feature extraction model.

9. The method according to claim 8, wherein the acquiring first reference image features and second reference image features of reference images in a first reference image set comprises:
performing the following processing on the reference images in the first reference image set:
adjusting a resolution of the reference image to obtain a third adjusted image of the reference image;
performing basic feature extraction on the third adjusted image of the reference image to obtain a third basic feature of the reference image;
performing pooling on the third basic feature of the reference image to obtain a third pooling feature of the reference image; and
performing feature sampling of different degrees on the third pooling feature to obtain the first reference image feature and the second reference image feature of the reference image.

10. The method according to claim 9, wherein the performing basic feature extraction on the third adjusted image of the reference image to obtain a third basic feature of the reference image comprises:
performing basic feature extraction on the third adjusted image of the reference image through a neural network to obtain a plurality of feature maps of the reference image, and using the plurality of feature maps as the third basic feature; and
the performing pooling on the third basic feature of the reference image to obtain a third pooling feature of the reference image comprises:
performing feature fusion on the plurality of feature maps to obtain the third pooling feature of the reference image.

11. The method according to claim 9, wherein the performing feature sampling of different degrees on the third pooling feature to obtain the first reference image feature and the second reference image feature of the reference image comprises:
acquiring a first compressed feature and a second compressed feature that are configured for compressing a feature dimension of the third pooling feature;
multiplying the first compressed feature by the third pooling feature to obtain a first multiplication result, and multiplying the second compressed feature by the third pooling feature to obtain a second multiplication result; and
performing non-linear transformation on the first multiplication result to obtain the first reference image feature of the reference image, and performing non-linear transformation on the second multiplication result to obtain the second reference image feature of the reference image.

12. An artificial intelligence (AI)-based image processing apparatus, comprising:
a memory configured to store a computer-executable instruction or a computer program; and
a processor configured, when executing the computer-executable instruction or the computer program stored in the memory to implement:
acquiring a first image feature and a second image feature of a preset image, and first reference image features and second reference image features of reference images in a first reference image set, a dimension of the first image feature and a dimension of each of the first reference image features being the same, a dimension of the second image feature and a dimension of each of the second reference image features being the same, and the dimension of the first image feature being less than the dimension of the second image feature;
determining first matching degrees between the preset image and the reference images in the first reference image set based on the first image feature and the first reference image features of the reference images in the first reference image set;
selecting, based on the first matching degrees, a preset number of reference images from the first reference image set to generate a second reference image set;
determining second matching degrees between the preset image and reference images in the second reference image set based on the second image feature and second reference image features of the reference images in the second reference image set; and
determining an image processing result of the preset image based on the second matching degrees.

13. The apparatus according to claim 12, wherein the acquiring a first image feature and a second image feature of a preset image comprises:
adjusting a resolution of the preset image to obtain a first adjusted image and a second adjusted image of the preset image; and
performing feature extraction on the first adjusted image and the second adjusted image respectively to obtain the first image feature and the second image feature of the preset image.

14. The apparatus according to claim 13, wherein the performing feature extraction on the first adjusted image and the second adjusted image to obtain the first image feature and the second image feature of the preset image comprises:
performing basic feature extraction on the first adjusted image and the second adjusted image respectively to obtain a first basic feature and a second basic feature;
performing pooling on the first basic feature and the second basic feature respectively to obtain a first pooling feature and a second pooling feature; and
performing feature sampling on the first pooling feature and the second pooling feature to obtain the first image feature and the second image feature of the preset image.

15. The apparatus according to claim 13, wherein the performing feature extraction on the first adjusted image and the second adjusted image is implemented by invoking a feature extraction model, and the feature extraction model comprises a basic feature extraction layer, a pooling layer, and a second adaptation layer; and
the performing feature extraction on the first adjusted image and the second adjusted image to obtain the first image feature and the second image feature of the preset image comprises:
performing basic feature extraction on the first adjusted image and the second adjusted image through the basic feature extraction layer to obtain the first basic feature and the second basic feature;
performing pooling on the first basic feature and the second basic feature through the pooling layer to obtain the first pooling feature and the second pooling feature;
performing feature sampling on the first pooling feature through the second adaptation layer to obtain the first image feature of the preset image; and
performing feature dimension reduction on the second pooling feature to obtain the second image feature of the preset image.

16. The apparatus according to claim 15, wherein the feature extraction model further comprises a first adaptation layer, and the method further comprises:
acquiring an initial feature extraction model and an image sample;
training a basic feature extraction layer in the initial feature extraction model based on the image sample to obtain a first feature extraction model;
freezing a parameter of a basic feature extraction layer in the first feature extraction model, and training a first adaptation layer in the first feature extraction model to obtain a second feature extraction model; and
freezing the parameter of the basic feature extraction layer in the first feature extraction model and a parameter of the first adaptation layer in the first feature extraction model, training a second adaptation layer in the second feature extraction model to obtain a third feature extraction model, and using the third feature extraction model as the feature extraction model.

17. The apparatus according to claim 16, wherein the training a basic feature extraction layer in the initial feature extraction model based on the image sample to obtain a first feature extraction model comprises:
adjusting a resolution of the image sample to obtain a fourth adjusted image and a fifth adjusted image of the image sample, using the fourth adjusted image as a reference sample, using the fifth adjusted image as a positive sample, and using other image samples as negative samples;
invoking the basic feature extraction layer in the initial feature extraction model to perform basic feature extraction on the reference sample, the positive sample, and the negative sample to obtain a reference sample feature, a positive sample feature, and a negative sample feature;
acquiring a first similarity between the reference sample feature and the positive sample feature and a second similarity between the reference sample feature and the negative sample feature, and constructing a first loss value of the initial feature extraction model based on the first similarity and the second similarity; and
performing parameter updating on the basic feature extraction layer in the initial feature extraction model based on the first loss value to obtain the first feature extraction model.

18. The apparatus according to claim 16, wherein the training a first adaptation layer in the first feature extraction model to obtain a second feature extraction model comprises:
invoking the first adaptation layer in the first feature extraction model to perform feature sampling on the reference sample feature, the positive sample feature, and the negative sample feature to obtain a reference sample sampling feature, a positive sample sampling feature, and a negative sample sampling feature;
acquiring a third similarity between the reference sample sampling feature and the positive sample sampling feature and a fourth similarity between the reference sample sampling feature and the negative sample sampling feature, and constructing a second loss value of the first feature extraction model based on the third similarity and the fourth similarity; and
performing parameter updating on the first adaptation layer in the first feature extraction model based on the second loss value to obtain the second feature extraction model.

19. The apparatus according to claim 16, wherein the training a second adaptation layer in the second feature extraction model to obtain a third feature extraction model comprises:
acquiring a feature sample set, the feature sample set comprising feature samples corresponding to a plurality of image samples and feature labels of the feature samples, and the feature labels being configured for indicating sampling features obtained by performing feature sampling on the feature samples through the first adaptation layer;
invoking the second adaptation layer in the second feature extraction model to perform feature sampling on the feature samples to obtain prediction sampling features of the feature samples;
determining similarities between the prediction sampling features of the feature samples and the sampling features indicated by the feature labels, and averaging the similarities to obtain a third loss value of the second feature extraction model; and
performing parameter updating on the second adaptation layer in the second feature extraction model based on the third loss value to obtain the third feature extraction model.

20. A non-transitory computer-readable storage medium, having a computer-executable instruction or a computer program stored therein, and the computer-executable instruction or the computer program, when executed by a processor, causing the processor to implement:
acquiring a first image feature and a second image feature of a preset image, and first reference image features and second reference image features of reference images in a first reference image set, a dimension of the first image feature and a dimension of each of the first reference image features being the same, a dimension of the second image feature and a dimension of each of the second reference image features being the same, and the dimension of the first image feature being less than the dimension of the second image feature;
determining first matching degrees between the preset image and the reference images in the first reference image set based on the first image feature and the first reference image features of the reference images in the first reference image set;
selecting, based on the first matching degrees, a preset number of reference images from the first reference image set to generate a second reference image set;
determining second matching degrees between the preset image and reference images in the second reference image set based on the second image feature and second reference image features of the reference images in the second reference image set; and
determining an image processing result of the preset image based on the second matching degrees.
